(19) United States
(12) Patent Application Publication
(10) Pub. No.: US 2014/0177676 A1
(43) Pub. Date: Jun. 26, 2014

(54) TEMPERATURE DETECTING DEVICE FOR HARD DISK DRIVE MODULE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/097,245

(22) Filed: Dec. 5, 2013

(30) Foreign Application Priority Data
Dec. 22, 2012 (CN) 2012105617761

(51) Int. Cl. G01K 1/14

(52) U.S. Cl. CPC G01K 1/14
USPC 374/208

(57) ABSTRACT

A temperature detecting device is arranged on a hard disk drive module. The temperature detecting device comprises a temperature detecting unit and a connection unit. The temperature detecting unit is arranged on a chassis of an electronic device having at least one hard disk drive module. The connection unit is arranged on a bracket of the hard disk drive module and connected between the temperature detecting unit and a cooling control system.

### BACKGROUND

1. Technical Field

The present disclosure relates to a temperature detecting device, particularly to a temperature detecting device for a hard disk drive module.

2. Description of Related Art

Electronic devices, such as computers and servers can have a plurality of hard disk drive (HDD) modules to store data. A fan control system can be used to control a plurality of fans to cool the plurality of hard disk drive modules. The electronic device has an air inlet and an air outlet. A temperature sensor is arranged at a side of the air outlet of the hard disk drive backplane to sense a temperature and send the sensed temperature to the fan control system. However, the fan control system cannot obtain a temperature of the air inlet opposite to the air outlet and far away from the hard disk drive backplane, thus the control of the fans may be inaccurate, and ineffectively cooling the hard disk drives.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of one embodiment of a temperature detecting device having a temperature detecting unit for a hard disk drive module.

FIG. 2 is a schematic of one embodiment of a circuit diagram of the temperature detecting unit of the temperature detecting device of FIG. 1.

### DETAILED DESCRIPTION

Reference will be made to the drawings to describe various embodiments.

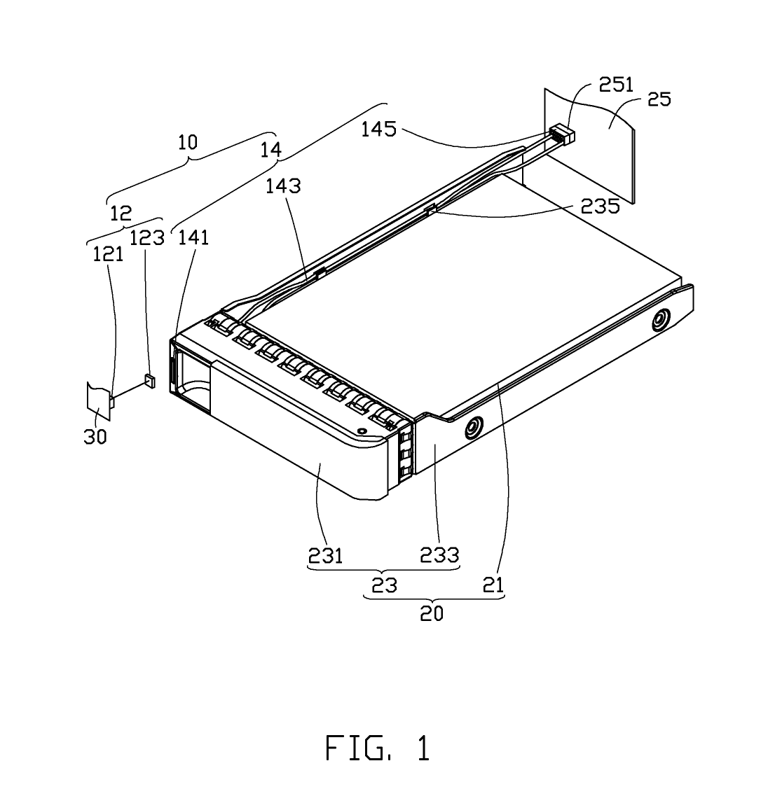

FIG. 1 shows a temperature detecting device 10 for a hard disk drive module 20. The temperature detecting device 10 is arranged within an electronic device, such as a computer, a server, or the like. The electronic device can include a plurality of hard disk drive modules 20. The temperature detecting device 10 comprises a temperature detecting unit 12 and a connection unit 14. The temperature detecting unit 12 is arranged on a chassis 30 of the electronic device. The connection unit 14 is arranged on the hard disk drive module 20.

The hard disk drive module 20 comprises a hard disk drive 21 and a bracket 23. The bracket 23 supports and fixes the hard disk drive 21 in the electronic device. The bracket 23 is U-shaped, and comprises a main body 231 and two arms 233 extending outwardly from opposite ends of the main body 231. The two arms 233 are substantially parallel to each other, and substantially perpendicular to the main body 231. The hard disk drive 21 is sandwiched between the two arms 233. The bracket 23 further comprises a plurality of hooks 235 protruding from an inner surface of each arm 233.

The temperature detecting unit 12 detects a temperature of a side of the chassis 30 which is opposite to the hard disk drive 21. The temperature detecting unit 12 can be arranged adjacent to an air inlet of a cooling channel of the hard disk drive 21. The connection unit 14 is arranged on the bracket 23 and connects the temperature detecting unit 12 to a cooling control system 25. The cooling control system 25 controls a plurality of fans (not shown) to cool the hard disk drive 21. The cooling control system 25 can be arranged on a motherboard or a hard disk drive backplane of the electronic device.

The temperature detecting unit 12 comprises a temperature detecting chip 121 and a first connector 123. The temperature detecting chip 121 is arranged on the chassis 30. The temperature detecting chip 121 can be a temperature sensor with a system management bus (SMbus) interface.

The connection unit 14 comprises a connection interface 141, a cable 143, and a second connector 145. The connection interface 141 is arranged on the main body 231. The cable 143 is connected between the connection interface 141 and the cooling control system 25 and can be secured to the bracket 23 by the hooks 235. The first connector 123 is plugged into the connection interface 141. One end of the cable 143 is electrically connected to the connection interface 141. Another end of the cable 143 is connected to the second connector 145. The second connector 145 is configured to connect to a slot 251 of the hard disk drive backplane or the motherboard where the cooling control system 25 is arranged. The second connector 145 is plugged into the slot 251. Both the second connector 145 and the slot 251 include a plurality of connection pins to establish an electrical connection therebetween. The cable 153 is secured on one arm 233 by the hooks of the bracket 13.

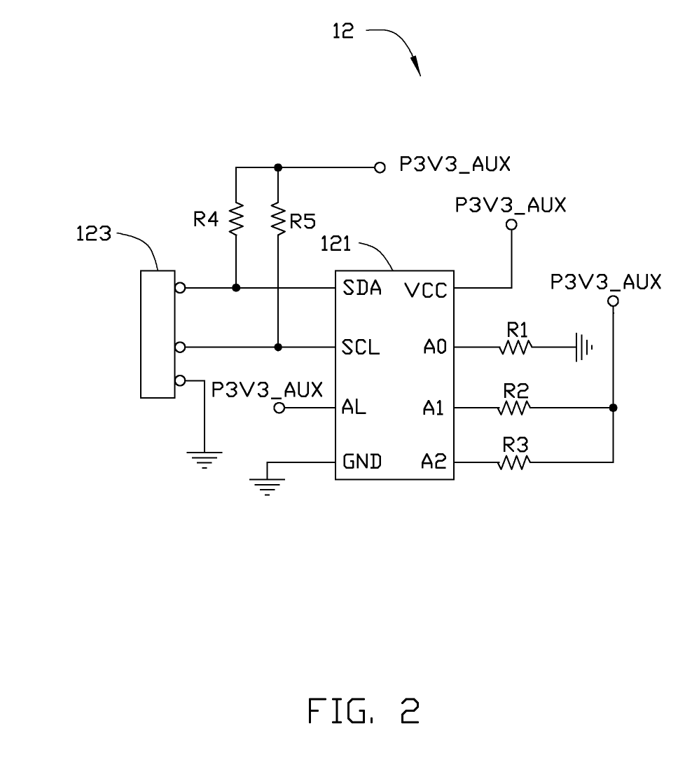

FIG. 2 shows a schematic of a circuit diagram of the temperature detecting unit 12. The temperature detecting chip 121 comprises a power pin VCC, a ground pin GND, address pins A0, A1, and A2, a data pin SDA, a clock pin SCL, and an alarm pin AL.

The power pin VCC is electrically connected to a power source P3V3_AUX. The ground pin GND is grounded. The address pin A0 is grounded via a first resistor R1. The address pins A1 and A2 are electrically connected to the power source P3V3_AUX via a second resistor R2 and a third resistor R3, respectively. The data pin SDA and the clock pin SC1 are electrically connected to the power source P3V3_AUX via a fourth resistor R4 and a fifth resistor R5, respectively. The fourth resistor R4 and the fifth resistor R5 can be pull-up resistors. The data pin SDA and the clock pin SCL are electrically connected to the first connector 123 via a system management bus.

In operation, the first connector 123 is plugged into the connection interface 141, so the temperature detecting chip 121 detects the temperature of the side of the chassis shell 30, converts the temperature into a digital signal and outputs the digital signal to the cooling control system 25 via the cable 143 and the second connector 145.

It is to be understood that even though numerous characteristics and advantages of the present embodiments have been set forth in the foregoing description, together with details of the structures and functions of the embodiments, the disclosure is illustrative only; and changes may be in detail, especially in the matter of arrangement of parts within the principles of the embodiments to the full extent indicated by the broad general meaning of the terms in which the appended claims are expressed.

What is claimed is:

1. A temperature detecting device for a hard disk drive module of an electronic device, the temperature detecting device comprising:
a temperature detecting unit arranged on a chassis of the electronic device;
a connection unit arranged on a bracket of the hard disk drive module and connected between the temperature detecting unit and a cooling control system of the electronic device.

2. The temperature detecting device of claim 1, wherein the temperature detecting unit comprises a temperature detecting chip and a first connector, the temperature detecting chip detects a temperature of a side of the chassis opposite to the hard disk drive.

3. The temperatue detecting system of claim 2, wherein the temperature detecting chip is a temperature sensor having a system management bus (SMbus) interface.

4. The temperature detecting device of claim 3, wherein the temperature detecting chip comprises three address pins, one of the three address pins is grounded via a first resistor, and the other two of the three address pins are electrically connected to a power source via a second resistor and a third resistor, respectively.

5. The temperature detecting device of claim 4, wherein the temperature chip further comprises a data pin and a clock pin which are electrically connected to the first connector.

6. The temperature detecting device of claim 5, wherein the data pin and the clock pin are electrically connected to the power source via a fourth resistor and a fifth resistor, respectively.

7. The temperature detecting device of claim 6, wherein the bracket is U-shaped, the bracket comprises a main body and two arms extending outwardly from opposite ends of the main body, the two arms are substantially parallel to each other and substantially perpendicular to the main body, and the hard disk drive is sandwiched between the two arms.

8. The temperature detecting device of claim 7, wherein the bracket further comprises a plurality of hooks protruding from an inner surface of each arm to secure the cable on the bracket.

9. The temperature detecting device of claim 8, wherein the connection unit comprises a connection interface, a cable, and a second connector, one end of the cable is electrically connected to the temperature detecting chip, and the other end connects to the second connector to the cooling control system.

10. A temperature detecting device for a hard disk drive module of an electronic device, the temperature detecting device comprising:
a temperature detecting unit arranged on a chassis of the electronic device; and
a connection unit arranged on the hard disk drive module; wherein one end of the connection unit is arranged on a bracket of the hard disk drive module and connected to the temperature detecting unit, and another end of the connection unit is electrically connected to a cooling control system of the electronic device.

11. The temperature detecting device of claim 10, wherein the temperature detecting unit comprises a temperature detecting chip and a first connector, and the temperature detecting chip detects a temperature of a side of the chassis opposite to the hard disk drive.

12. The temperatue detecting system of claim 11, wherein the temperature detecting chip is a temperature sensor having a system management bus (SMbus) interface.

13. The temperature detecting device of claim 12, wherein the temperature detecting chip comprises three address pins, one of the three address pins is grounded via a first resistor, and the other two of the three address pins are electrically connected to a power source via a second resistor and a third resistor, respectively.

14. The temperature detecting device of claim 13, wherein the temperature chip further comprises a data pin and a clock pin which are electrically connected to the first connector.

15. The temperature detecting device of claim 14, wherein the data pin and the clock pin are electrically connected to the power source via a fourth resistor and a fifth resistor, respectively.

16. The temperature detecting device of claim 15, wherein the bracket is U-shaped, the bracket comprises a main body and two arms extending outwardly from opposite ends of the main body, the two arms are substantially parallel to each other and substantially perpendicular to the main body, and the hard disk drive is sandwiched between the two arms.

17. The temperature detecting device of claim 16, wherein the bracket further comprises a plurality of hooks protruding from an inner surface of each arm to secure the cable on the bracket.

18. The temperature detecting device of claim 11, wherein the connection unit comprises a connection interface, a cable, and a second connector, one end of the cable is electrically connected to the temperature detecting chip, and the other end connects to the second connector to the cooling control system.
